(19) United States
(12) Patent Application Publication
(10) Pub. No.: US 2007/0036395 A1
(43) Pub. Date: Feb. 15, 2007

(54) Reverse identity profiling system with alert function

(76) Inventor: Sheri Lee Okun, Decatur, GA (US)

Correspondence Address: Sheri L. Okun, 3255 Burgundy Road, Decatur, GA, 30033, US

(21) Appl. No.: 11/203,856

(22) Filed: Aug. 15, 2005

(51) Int. Cl. G06K 9/00

(52) U.S. Cl. 382/115; 340/5.52

(57) ABSTRACT

The present invention is a universal biometric monitoring system designed to locate and track terrorists, criminals, and missing or displaced persons. Via various checkpoints and a plurality of identity verification or observation ports, defining identity characteristics or biometric data is transmitted to a system that cumulatively creates a database and identity related profiles. The uses of the system are three-fold. Data is retrieved and examined in order to: Find, isolate, and restrict wanted individuals; Locate missing children; Bring order and identity resolution to groups of individuals, most specifically individuals displaced resultant to disaster situations. The system is capable of retrieving, capturing, transmitting, analyzing, and otherwise examining biometric data, cumulatively building identity profiles, and has the ability to search, match, find, trace and track identities through this system as well as set off a multiplicity of alert outputs and alarms.

### BACKGROUND OF THE INVENTION

The state of technology pertaining to definitively identifying and/or recognizing individuals via electronic and/or technical means such fingerprints, irises, voice, handwriting, facial features, DNA, gestures and more is becoming readily available. Identity verification systems are currently being used to allow or restrict access to buildings, computers, and equipment. Financial institutions and credit card companies are promising it as the future of prevention of identity theft.

Many ideas have been generated as to how verify the identity of individuals on a more global basis in arenas such as airports to aid in preventing terrorism and crime. Some of these methods require a national identification card, storing biometric data for comparison, Haala, Catherine A., National Identification Card System And Biometric Identity Verification Method For Negotiating Transactions Appl No. 20050005172, Jan. 6, 2005. This theory attempts to close the large loopholes of the system this country has had in place for over a century, the process by which individuals, for passage in certain situations, show a form of paper identification, such as a driver's license, social security card, birth certificate or passport, to prove an individual is who they purport to be. Clearly this system is ineffective. False identification cards are easily created, especially considering the multiplicity of forms of identification cards, multiplicity of states having varying formats for driver's licenses, etcetera. The other problem is that genuine identification cards are often given out to individuals purporting to be someone whom they are not, thus the cards include false identity information. Criminals simply have more than one identity.

Now, the current theory of verifying the identity of an individual with biometric measures in conjunction with a universal and data-carrying identification card narrows these loopholes but in no way eliminates them. Criminals and terrorists will generate false identification cards or obtain genuine cards with false names, whether they include biometric data or not. Further, these systems impose serious burdens on the general population and create problems in the cases of international visitors whom have not been mandated to carry a biometric identity card.

Other systems attempt to supplement or integrate the subjective, tangible and manual proof of identity (such as a driver's license or passport currently required at airport security checkpoints) with biometric proof via fingerprint and/or iris scans, video, and other advanced identification methods, Kyle, Wayne: The Identity Verification System. Appl. No. 437328, May 13, 2003. U.S. Pat. No. 6,853,739; Nanavati: Samir H., Nanavati: Rajkumar H, Identity Verification Method Using A Central Biometric Authority, Aug. 9, 2005. U.S. Pat. No. 6,928,546; and Sweatte, Clifford; Method And System For Airport And Building Security; Jan. 6, 2004; U.S. Pat. No. 6,674,367.

These systems, as well as the aforementioned theory of a national identification card, are effective only under the circumstance that every individual entering a specific security checkpoint is mandated to participate, thus has been previously been identified, had biometric data entered in the system, and in the case of the national card, been issued a card. These systems are limited in that they are effective only with finite groups of people. Limitations exist on a global level.

Another form of identity recognition is an age-old system used by law enforcement whereby manual (or scanned) fingerprints and photographs of arrestees are collected and documented at intake. Those prints and photographs are entered into a system for future reference. Further, facial recognition systems are being used by law enforcement to match photographs. Similar to the aforementioned Identity Recognition System, this system is limited, as it is exclusive to a particular and finite group of individuals, in this case, those who have been entered at intake at a correction facility or other like scenario. The fingerprint and photograph identification system used by government and law enforcement shall be greatly enhanced and supplemented by the present invention.

Additionally, an effective, though limited system in place to track missing children is the AMBER Alert System. This system will be greatly enhanced; facets of this system may also be used in searching for not only children, but also wanted individuals in general as well as individuals displaced in disaster situations. Outside of doing manual DNA testing or the invasive and unproven procedure of placing chips in children, the AMBER alert system is the only universal system in place to help find missing children, and the limitations of the system are many, for example, it is subjective and relies on the input of witnesses. Lastly, there is no system in place to bring order to chaos in widespread disaster scenarios.

### BRIEF SUMMARY OF THE INVENTION

The present invention is a system and procedure that retrieves and captures identity information from existing identity verification ports as well as custom identity observing ports. The system immediately examines the data for various types of matches, immediately searching to establish whether or not the identity information it receives matches that contained on any “wanted” or restricted list. The system determines correlations, codes, categorizes, stores, and disseminates identity related information cumulatively and continually with search and alerts functions built-in and preprogrammed to trigger internally or externally in the event of various matches. All of this is accomplished without having to verify the identity of any individual.

The objective of the present invention is to create a foolproof system to protect good individuals from the bad without necessarily imposing a burden on the general public. The goals of the system are tracking terrorists, finding missing and displaced persons, controlling and thoroughly monitoring our borders, capturing escaped convicts, solving crimes, finding suspects on the run, deporting illegal aliens, and generally keeping Americans safe in their homeland. Concurrently, this invention may allow companies, institutions, retail stores, restaurants, establishments, and employers who subscribe to this system, to monitor individuals who enter their premises, screen applicants for positions within their companies, receive updates on new and newly altered public information regarding particular individuals or particular categories of individuals, offer philanthropic aid and more. This system may also specifically aid in the creation of order during national or worldwide disasters.

Rather than actually or necessarily verifying the identity of individuals, the present system is effective sheerly by obtaining biometric data or defining identity characteristics of individuals via the retrieval of such information from existing or custom identity observation ports and databases, and performing analytical matches based on each and every defining factor or piece of biometric data to the existing database and central processing system, described herein as the Cumulative Interactive Database of Identity Recognition (the central component of the present invention), which may certainly hold any other title. The system does not require an identity to be verified, (though when available it accepts and benefits from the more complete set of information obtained through an actual verification of identity), rather it requires the defining identity characteristics (i.e. fingerprint, iris scan, signature, passport) to be logged at the time of passage through an identity observation port and immediately sent electronically to a central processing unit, for instantaneous evaluation and potential output activity. The output only necessarily occurs in the event the defining identity characteristics match with one in the database of a wanted nature.

The system instantaneously codes, matches and otherwise sorts the incoming data (defining identity characteristics and/or biometric data), location scanned and time of passage at the particular location). The system holds all of the locations (addresses) the particular defining identity characteristic(s) was captured, and that data is recorded along with the exact time of access, and is saved for access with all other defining factors available regarding that individual (whose exact identity may be known or unknown). The system is able to perform searches based on any defining identity characteristic as well as times, locations scanned, and/or category, etc. The present system has alert functions built in as well as methods to connect with and set off external alert systems based on preprogrammed data, and point on point matches of “wanted” defining identity characteristics.

### DETAILED DESCRIPTION OF INVENTION

A. Components:

1. Identity observation ports are security-type checkpoints that allow, restrict, observe, or otherwise monitor entry or access to particular locations or devises via any one form or combination of defining identity characteristics. Individuals shall be required, for passage in certain situations, to enter various identity observation ports.

A port may be categorized as a “custom port” (dedicated solely to the present invention) or “external port” (accredited for use with the present invention). These ports may be categorized as “passage ports”, which are mandatory, or “remote ports” which are voluntary. Remote ports are either emergency ports or non-emergency ports. Ports may be categorized as “verification-access ports” whereby for authorization the port must be able to specifically match an individual's proper name or identity with one or more required advanced identity characteristic specifically authorized to access; or “observation-restriction ports” whereby one or more required advanced identity characteristic is obtained and captured in order to make passage or access, restricting only those individuals producing one or more specific defining identity characteristic the system is specifically programmed to restrict, those of “wanted” individuals. The ports may also be classified either governmental ports (run by governmental agencies) or personal ports (run by accredited corporations or individuals). To follow are examples of ports that may fall within these categories:
i) Governmental Passage Ports (mandatory, either observation or verification): US airports, US borders, train stations, bus stations, rapid transit stations, US cruise ships ports, US marinas, license plate and tag offices, drivers license application, passport application, correction facility and/or prison intake.
ii) Personal Passage Ports (mandatory for all by choice of establishment or business owners, observation): Malls, stores, bookstores, employers, philanthropic organizations, pediatricians, chain stores and any other corporation seeking the information, philanthropic opportunities, or various capabilities this system provides.
iii) External Remote Passage Ports (voluntary, identity): Any accredited and participating institution which uses an accredited identity scanning devise such as fingerprint scanner, iris scanning or other type of electronic signature in a digital and/or other electronically transmittable medium and definitive universal verification to restrict or allow entry or access, such as those systems designed (or in the process of being designed) for employees, bank customers, alarm systems, automobile ignitions, credit card processing, and/or computer operators, whereby individuals shall be required to have their identity scanned in some definitive and universal fashion in order to gain access. Via the present invention's custom redirector software, at the time of identity scan, the advanced defining identity characteristics scanned are immediately sent to the Cumulative Interactive Database of Identity Recognition and Network and scanned for matches, evaluated, categorized and utilized.
iv) Emergency Remote Ports (voluntary, observation): any remote location whereby the government, or accredited individual or corporation installs and maintains an identity observation port linked to directly to the main Network in order to help ensure the safety of missing persons or children, whereby that person could simply engage their print, face for photograph, iris and/or other advanced defining identity characteristics to be scanned in an emergency situation in order for that individual to be isolated and located. Remote Ports may include mobile and portable devices, nomadic in nature at various permanent or temporary locations.
v) Non-Emergency Remote Ports (voluntary, identity): accredited sites whereby an individual may voluntarily have themselves or their minor children entered into the system by way of any and all available means of identity recognition in order to be an active participant and fully entered into The Cumulative Interactive Database of Identity Recognition and Network in the event of a potential future emergency event involving that individual (for example, a child goes missing).

2. Defining identity characteristics (“DIC”) are the integral components that feed the present invention. DIC's are herein defined as specific, accurate, categorical, electronically transmittable characteristics that define an individual. Defining identity characteristics are broken down into four categories:
i) Advanced Identity Characteristics are high-tech DIC's, biometric data, such as electronic fingerprint, electronic iris, facial recognition, photograph, video, handwriting, voice recognition, DNA.
ii) General Identity Characteristics are included in transmittal when available and linked to more definitive forms of identity characterization. These are descriptors such as height, weight, race, build, eye color, hair color, photographs. These descriptors are usually entered in conjunction with one or more specific DIC.
iii) Public Identity Characteristics is information which is generally of public record, such as the individual's name(s), current address, past addresses, phone number, email address, citizenship, state of residence, past and present convictions, whether or not they are currently on probation, are a convicted child molester, on any governmental ‘wanted’ list, illegal alien, whether they are a missing child, escaped convict, terrorist, etc.
iv) Nomadic Identity Information is information about the time, location, physical address of the identity observation port in which the DIC scan and/or entry took place.

DIC's and/or biometric data is retrieved from the ports and is sent to a universal system, herein referred to as, the Cumulative Interactive Database of Identity Recognition and Network (though any other name may be given to the system). Other DIC's are input manually and/or downloaded from existing databases holding identity recognition data.

3. The universal system, or CIDIR, receives defining identity characteristics electronically and instantaneously via identity observation ports and via electronic and/or manual entry or downloads by law enforcement agencies per arrests, searches and other means. The system scans, examines, attempts to match the data and find correlations in a multiplicity of fashions, the first of which being determining if the defining identity characteristics received match directly with defining identity characteristics of any wanted identity. Built into the system are methods and means such as specialized software designed to match and search and otherwise examine and manipulate biometric data and other DIC's.

All of the identifiers are categorized by any and all information within a profile (including the addresses, times and locations where DIC is scanned) and may be searched by each and any of the segments. (Whether an existing external recognition port allows or denies access to an individual based on their scan is of little import to the present invention as this invention receives useful defining identity characteristics in both scenarios).The system is categorized and searchable by any and all defining identity characteristics it retrieves, codes under, and logs.

Continually receiving, categorizing and matching data, the system cumulatively builds an identity profile for each individual. Identity profiles are defined as a set of corresponding defining identity characteristics for an individual. For example, should a scanned fingerprint and accompanying signature be entered into the system that matches with a previously entered and corresponding iris scan, facial photograph and that same signature, that fingerprint would now be a part of the set of defining identity characteristics or building profile on that individual. The system scans, and continually builds upon and updates all available DIC for a given individual or profile. The system also logs the whereabouts and time the defining identifying characteristic was captured and includes such a log with each profile.

A useful aspect of the search factor and cumulative nature of the system is the ability for government and law enforcement to categorize and search ongoing (manually and/or via pre-coded search alerts) for fingerprints, photos, or other definable identifying factors of individuals these agencies are seeking (or shall be seeking at a future point in time).

For instance, law enforcement may be seeking a suspect of an unknown personal identity whose fingerprints were at crime scene and on a murder weapon. In this scenario, law enforcement would scan and enter the prints into this system, (under a wanted category with specific instructions preprogrammed in the event of a match). In this instance the prints either present a match with an existing profile (no matter how complete or incomplete the profile is), or no match would found at the time of entry; however, the cumulative nature of this system would help discover the whereabouts of that individual on a continual-time/location basis. If the system were active at borders, airports and other mass transit systems, for instance, the suspect would not get far without his prints having to be presented at an identity observation port.

4. The Alert Function is a preprogrammed output function of this system, whereby the system is automatically and instantaneously triggered to perform specific functions based on particular coded matches. Specific instructions are coded with a wanted defining identifying characteristic or profile itself, which are triggered and interplayed immediately upon a match. Further, at the time “wanted” DIC's and/or biometric data is originally inputted into the system, it is manually linked with a specific “wanted” category and rank set within thus that information and instructions per category and rank link are already programmed to trigger and the system is equipped and set up to play out the occurrence in the event a port scans that “wanted” DIC. For instance, immediate output will occur if a DIC matches with one on any particular wanted category, wanted list, or category of interest (including but not limited to the FBI's most wanted list, escaped convicts, convicted felons, known terrorists, missing children, individuals on probation or on national stalking list, etc.), due to preprogrammed instructions pertaining to the specific matches in specific categories and ranks within those categories. The components of this alert system include but are not limited to various custom or external systems such as alarm systems, electronic transfer systems, electronic sign systems, air traffic control, an interactive database of emergency contacts, and so on.

The method can be likened somewhat to an alarm system on a house automatically dialing the local police, fire department, or ambulance, depending on the panic button pushed on the system; however, in the present invention, rather than an individual pushing a panic button, the system automatically triggers the alert output system to perform its preprogrammed tasks, such as triggering alarms and/or disseminating information.

The system may be synched with alarm systems in public or governmental buildings and may have preprogrammed instructions and mechanisms to lock buildings, signal an Amber Alert, or an Amber-type alert for a wanted adult, signal alarms, contact air traffic control, the coast guard, city ground traffic alert systems, radio station networks, television networks, or any other appropriate preprogrammed entity. These systems are triggered by a point-on-point scan of specific defining identity factor (such as those of a scanned fingerprint iris, photograph, video, handwriting) matching exactly to that on a list of interest preprogrammed in the system. Government and/or law enforcement, or other authorized individuals or entities, as well, may manually trigger the alert system in emergency situations, whereby information is obtained outside of the traditional means of the recognition system.

Moreover, the alert output system has specific instructions pre-coded for each physical location holding a recognition port, and each category of port, such as an airport, border, etc. In other words, the preprogrammed instructions in the alert output function at an airport are different than those in a federal building, in the event a wanted defining identifying characteristic is scanned. Each wanted fingerprint is categorized, ranked and coded and triggers specific instructions per location as described above. The particular nuances of each location are intricately woven into the alert output system of the present invention. For example, true alarm systems may be activated, doors may be locked, an electric shock may be administered via the machine, all via the encoded instructions specific to each particular location per the triggers of a particular defining identity characteristic and/or biometric data match. The alert system may also contain that of a global database of emergency contacts (from law enforcement and government to media) as well as instructions and means to activate the contact of those individual's or entities via location based matches.

Still another facet to the alert system, is the alert system input whereby emergency updates to the database which are controlled by law enforcement or accredited agencies or entities and include but are not limited to instances when a child is reported missing or during an AMBER alert, in the case a convicted violent felon escapes from prison, in the case a fingerprint is available of a known terrorist, or armed or dangerous suspect of any kind, trigger instant updates as well as any other service the system offers. The emergency update system has capabilities to immediately flash photos and any other available information about the updated individuals on each monitor associated with and/or linked to the system. Via this same method, the emergency update system would immediately flash photos and any other available information about the updated individuals or situation.

The system may also offer output of a non-emergency nature, such as in the case of a match with a category of interest. An example of such being, an individual is convicted of child molestation and a participating subscriber has paid for updated lists of those convicted of child molestation who have traveled in a specific radius of a given location (should this be deemed legal information to disseminate) or have visited one of their stores, etc.; the system would indicate convicted child molesters as a category of interest, and search for the data the subscriber asks for, the output function may have the capability of automatically updating that subscriber (either via email, or another method preprogrammed in the system per subscribers request).

The output and alert functions of the present invention is a multi-functional facet and may be used by government, law enforcement and/or other accredited entities in a variety of manners. The overall function of the alarm component of the present invention to alert the public of emergency situations, and inasmuch may be used in any manner by the government to fulfill the same.

5. Child-Find is an aspect of the present invention designed to locate missing persons, aid in robberies and/or other on-site emergencies. This system includes a panic button feature which may be linked to the universal system, alert system and/or other systems such as bank machines and/or other specific apparatus and machinery set up to automatically scan fingerprints, irises, read hand geometry, take photos, video, and/or recognize faces via facial recognition technology, or any other devise available to receive and then transfer biometric data and/or personal identifying data.

A missing child or adult may access the system simply by pushing a panic button, standing in front of the machine, which may have a camera in addition to other biometric and/or identity recording devices, having their identity scanned and/or recorded in the fashion(s) the machine is designed to intake it. After the panic button is pushed, data is instantaneously sent to the central processing unit and database and/or to the closest police department and an sort of ‘output alert’ for ‘located missing person’ is triggered. The trigger of such automatically begins comparing the data received to a specific database of missing persons at the central processing unit. Other entities may be programmed to receive information, such as the National Center for Exploited or Missing Persons.

The same may be incorporated on pc's having direct links to the system via the Internet, with a child-find and/or panic key on keyboards (acting as a function key). In the latter scenario, a child or other individual would either key in freehand information, such as their name (if know) or other statements. If a video component to the pc is available, the panicked individual would simply sit in front of the camera, speaking or not. The link, including all data received would go directly via instant message, direct link, or dial up to entities it is preprogrammed to reach such as 911 in the area in which the entry was made, National Center for Missing and Exploited Children, and/or other entities including the central database, specifically the database of missing children and other individuals, and taken care of appropriately, as the location, and potential identity of the missing person or panicked individual could be simply determined.

6. Order in Chaos: This system universally aids in creating order after a national or worldwide disaster. In these types of situation children may be separated from their parents, and the Reverse Identity Profiling System shall be the universal system in these types of scenarios which aids in determining the location of lost loved ones, and to determine who has perished. The Reverse Identity Profiling System is a system with the abilities to manage this chaos and bring missing individuals back to their families; by tracking and logging where these individuals are located.

Disaster stricken and evacuated individuals may be found and tracked via the Reverse Identity Profiling System with Alert Function via the mobilization and implementation of fingerprint and/or other biometric scanning and data entry devises at evacuation shelters and sites as well as governmental ports whereby biometric data and/or other simple defining identity characteristics, such as an individuals name, birth date and possibly city of residence, is scanned and/or keyed into a database system specific to the disaster. The system then builds progressively, a database of the identity of individuals (with or without biometric data attached) who have been displaced due to a disaster. As in the other facets of the Reverse Identity Profiling System, each of the components of entry into the system is searchable, in this type of scenario, the searchable components would be made available and public to evacuees who have been entered into the system, volunteer and philanthropic organizations offering aid, companies donating services, as well as governmental agencies and those manning the system. Thus, a general tracking system is in place in every imaginable manner for these entities. From tracking the location of loved ones for the evacuees, to governmental statistics needed to the exact number and locations of evacuees, to the locations they have come from, to their names, past salaries for unemployment payout and related services, ability to determine and disperse to the individuals, account numbers and access codes individuals need to their bank accounts and/or other accounts, this system aids in bringing identity related order to chaotic environments.

B. Mechanisms Required:

1. Equipment:

The present invention runs on any computer system compatible to the software, database system, control unit and network developed, with output ports and accessory ports in which identity scanning and or verifying apparatus may be accessorized. The devise may be physically or remotely attached to the pc and network. The network may be internal (within the building) or external (at a remote location), mobile or fixed. The system works alone and/or in conjunction with a multiplicity of verification or identity observation systems such as that of swiping a credit card, which has a system in place for verifying the card is active and that credit processing is authorize, in this scenario, data pertaining to the individual's identity is immediately transferred to the central processing unit of the present invention.

Supplemental (voluntary) component of a video camera to photograph individuals in sync with and other DIC input, scanning and/retrieval and a recording of such sent to database with print other pertinent information for monitoring or other purposes.

It is important to note that the present invention is not only adaptable to the input device of one type of DIC scan. It is capable to retrieve many types of identity information and use the various types to link identities and build profiles. Various forms of identity recognition instances available and future forms, not yet available, shall be incorporated in the database, its retrieval system, and incorporated therein with the relational, matching, alert and other functions and systems the present invention offers. The emergency database contacts may also be exclusionary access.

Direct information output may be set up to be triggered at some locations and/or ports only in the instance of an alert identity match, and in the instance of an emergency immediate download. In some instances, information is exported and imported to a sub-network built for each port or group of ports instantaneously and updated regularly (hourly for example) via the mainframe (main network).

Information disseminated to certain centers may be restricted and/or encrypted via regulations, governmental privacy, codes of silence or information allowable as a matter of law; however, the information outputted by these sub-networks, relaying with the mainframe, then outputted to governmental type ports, and would then display and include all information available and/or necessary.

Additional equipment or mechanisms may include:

central processing unit(s),

data input devise,

network, Internet, direct and or wireless communication means

reformatting mechanisms,

compressed files,

keyboards,

monitors,

hard drives,

printers,

external equipment,

biometric observation and recording devises,

transmitting devices,

redirector software, interceptor software,

systems and software to compress and reformat files,

encryption and decryption methods and mechanisms,

biometric data analyzing mechanisms and/or software;

alarm systems, and/or

child find specific mechanisms such as panic button, system, machine described.

existing biometric and/or general identity related databases

database management tools

database software

1. A reverse identity profiling system with alert function, the profiling system comprising:
(a) custom identity observation ports designed specifically to capture defining identity characteristics and/or biometric data of individuals at a multiplicity of locations, as a matter of procedure; each having computer monitor(s), computer keyboard(s), hard drive, biometric identity intake devise(s), connecting means and bi-lateral communication means and methods to connect with a destination or central processing unit, a transmission means, a compression means, reformatting means, receiving means, and conversion means, whereby the data is transmitted directly or indirectly to a central processing unit;
(b) existing identity verifying type ports collecting electronically transmittable identity information, biometric or otherwise, for a plurality of other purposes such as credit card transactions, bank transactions, building entry, passage security, etcetera; having data intake means, connecting means, and a transmission means;
(c) the transmission of defining identity characteristics and/or biometric data instantaneously from these various identity recognition checkpoints or ports and/or devises as well as from existing database systems for use with this system, whereby the data is transmitted directly or indirectly to a central processing unit,
(d) the central processing system comprising
a database of biometric data and defining identity characteristics,
software, systems and methods built-in which recognize, analyze and match biometric data and/or defining identity characteristics,
receiving means and method(s) by which the electronic biometric data and/or defining identity characteristic data is captured from existing identity apparatus or transmission devises, this system capable of receiving data in a multiplicity of formats, reformatting the data, converting data to the format(s) most useful to the system or facets of the system,
a connecting means to connect with the apparatus from which the data is sent,
a means to be in continuous bidirectional communication with some or all of the entry ports or devises, other devises, ports, databases and/or networks from which the data is sent and or other systems,
means and methods to read, interpret, receive and analyze incoming biometric data and defining identity characteristics live from any one or combination of identity verifying apparatus,
means and methods to continually and cumulatively build upon biometric data, create profiles and reverse identity determination,
means and methods to manually flag and/or enter advanced defining identity characteristic and/or biometric data under a restricted or wanted list within the system, with instructions preprogrammed,
means and method to manually enter wanted individuals or identity characteristics directly or indirectly into this system and code, categorize the same,
means and methods to trace and/or track the past and/or present location of certain defining identity characteristic(s) and/or biometric data and the day and time the biometric data was scanned on-site at the various locations,
means and methods to search the incoming data for a match with any biometric data or identity profiles in which have been manually entered on a wanted list,
means and methods to search the incoming data for overlaps and matches of incoming biometric data with biometric data currently in the system,
means and methods to add newly received biometric data and/or defining identity characteristics to the profile in which the data overlaps with or belongs to,
means and methods to search all facets of the system manually;
means and methods to automatically search continually for incoming data and/or matches and correlations,
means and methods to store and compress information and data,
means and methods to code data manually and automatically,
means and methods to match data manually and automatically,
means and methods to categorize data manually and automatically,
means and methods to trigger various portions of the system,
means and methods to receive data from entry ports instantaneously,
means and methods to receive data via downloads,
means and methods to direct and program various action items to occur via triggers manually or spontaneously inputted into the system,
means and methods to automatically and manually monitor, man and maintain the system, and trigger output functions,
a recognition system for operators and other individuals authorized to access or manipulate the system;
(e) an automatic alert output function and system, the system, method and apparatus comprised of
an interactive database of emergency contacts and transmittal means in order to transmit information from the main system, the central processing unit, to those contacts (from law enforcement and government to media),
method and means to set the system to activate individualized alarm systems and other technology-based proactive systems (based on each port's nature and location),
means and methods to automatically trigger alarms,
means and method to key in preprogrammed data which when triggered will be immediately activated in the manner preprogrammed by the factor in which activated such trigger,
means and method to automatically trigger existing alarm systems and override and or direct functions via electronic signals,
means and method to trigger and activate all, or specific portions of specialized alarms, existing electronic signs, and various other systems in the event of a specific wanted identity match,
means and method to preprogram activities and output triggered by certain coded matches at the time of a scan transmittal and/or in the event of a manual system input,
means and method to trigger electronic events and communication, such as faxes, instant messages, phone calls and other wireless, Internet based, network based, and/or directly or indirectly linked communication processes based on coded matches,
means and method to output information and immediately signal match, to the operator at a mandatory port/and or other entities preprogrammed and/or coded in the system in the event of that type of or particular match,
means and method to interconnect, send, receive, and display information to/from air-traffic control, coast guard, homeland security, police precincts, 911 operators, airport personnel, and/or other entities preprogrammed and coded in the system,
means and method to manually enter wanted individuals or identity characteristics directly or indirectly into this system and code, categorize the same,
means and method to electronically disseminate information manually coded and/or categorized or freehand in alert situations to particular, categories of, specific, or all receiving entities linked to the system,
means and method to manually activate triggers,
a recognition system for operators and other individuals authorized to access or manipulate the system,
means and method to correlate the entire alarm function with all other aspects of the reverse identity profiling system;
(f) a process to find missing persons whereby
one or more defining identity characteristics or biometric data is entered into and/or exists in the database system,
the missing individual's information is entered and activated under a its respective wanted category, and as such is preprogrammed to trigger spontaneous alert output in the event
the missing individual is scanned, entered and/or observed at any identity observation port which immediately transfers electronic defining identity characteristics matching one or more of the same in the database,
the alert output functions in the manner in which it was preprogrammed to function,
and the system is searchable allowing individuals, governmental organizations, philanthropic organizations, or those manning the matches on the system to recover missing loved ones;
(g) a process to find persons of wanted or restricted nature whereby
one or more defining identity characteristics or biometric data of the restricted and/or wanted individual is entered into or exists in a universal processing system,
the information is entered and activated under a category or subcategory that automatically searches the system internally and searches the intake sites or ports for defining identity characteristics and/or biometric data of the wanted or restricted person and as such is preprogrammed to trigger alert output and/or restrict access,
the wanted individual is scanned, entered and/or observed at any identity observation port which immediately transfers electronic defining identity characteristics matching one or more of the same in the database,
the alert output functions in the manner in which it was preprogrammed to function.

2. The reverse identity profiling system of claim 1, whereby claim 1(b), (c), (d), (e), (f) and (g) are mutually exclusive with claim 1(a), thereby claim 1(a) may be used singularly or with any other system and claim 1(b), (c), (d), (e), (f) and (g) may be used together with or without any other system.

3. The reverse identity profiling system of claim 1, whereby claim 1(a), (d), (e), (f) and (g) are mutually exclusive with claim 1(b) and claim 1(c), thus claim 1(b) and claim 1(c) may be used together with any other system, and claims 1(a), (d), (e), (f) and (g) may be used together exclusively or with any other system.

4. The reverse identity profiling system of claim 1, whereby claim 1(a), (b), (c), (e), (f), and (g) are mutually exclusive with claim 1(d), thus claim 1(d) may be used singularly or with any other system, and claim 1(a), (b), (c), (e), (f), and (g) may be used with any other system.

5. The reverse identity profiling system of claim 1, whereby claim 1(a), (b), (c), (d), (f) and (g) are mutually exclusive with claim 1(e), thus claim 1(e) may be used singularly or with any other system, and claim 1(a), (b), (c), (d), (f) and (g) may be used together, alone or with any other system.

6. The reverse identity profiling system of claim 1, whereby claim 1(a), (b), (c), (d), and (e) are mutually exclusive with claims 1(f) and 1(g), thus claim 1(f) and 1(g) may be with any other system, and claim 1(a), (b), (c), (d), and (e) may be used together without the processes described in 1(f) and 1(g).

7. The reverse identity profiling system of claim 1(c), whereby the alert function is used in conjunction with and/or may be integrated with various external systems including any alarm system or alert system, electronic transfer systems, electronic sign systems, air traffic control, AMBER Alert system, locking system and/or information relay system.

8. The reverse identity profiling system of claim 1, wherein the electronic defining identity characteristic and/or biometric data is fingerprint(s), iris, facial template, DNA, saliva and/or geometric hand data, retrieved with respective specialized devises to read such.

9. The reverse identity profiling system of claim 1, wherein the electronic defining identity characteristic and/or biometric data is a passport number, green card number, visa number, social security number, driver's license number, bank account number, credit card number and/or member number, information of public record about an individual, the individual's name, and/or physical descriptors of an individual, or any combination thereof.

10. The reverse identity profiling system of claim 1, wherein the electronic defining identity characteristic and/or biometric data is a handwriting sample, signature, photograph, streaming video, composite sketches, and/or voice recording, physical descriptors of an individual, retrieved with respective devises to intake such.

11. The reverse identity profiling system of claims 1, whereby the software and systems which analyze and match biometric data is any custom or existing technology or system designed to match the biometric data against a database or other system, including but not limited to those of facial recognition systems, fingerprint matching systems, iris evaluation and matching systems, voice recognition systems, handwriting analysis systems or any combination thereof.

12. The reverse identity profiling system of claim 1, whereby the data is received directly or indirectly from an automated bank machine or credit processor, from a bar code reader, access or smart card reader, keyboard and/or scanner.

13. The reverse identity profiling system of claim 1, whereby the data is received directly or indirectly from an alarm system, building access code, password, passcode, and/or electronic key or token.

14. A reverse identity profiling system, the profiling system comprising a system whereby missing children and/or panicked individuals may activate any one or more of various devises designed specifically to aid missing children and/or individuals in emergency situations, that instantaneously convey the child's (or other individual's) identity, or portions of the identity that have been previously entered into an identity profiling and/or verification system comprising a
(a) devise with panic feature installed in conjunction with one or more identity recognition devises,
(b) panic feature linked to an alarm and/or alert system,
(c) identity recognition devise with panic activation having means and methods to obtain, retrieve, receive and transmit the biometric data,
(d) biometric data and panic signal are transmitted to respective destinations via network, wireless transmission, the Internet or any other direct or indirect communication link,
(f) panic button activation signals multiplicity of entities including local law enforcement via direct links and or systems such as those described in claim 1(e) of the present invention,
(g) panic button creates an immediate alert function and the system may be used in conjunction with that in claim 1(e),
(b) which when activated via the panic button, immediately alerts the system and/or authorities via preprogrammed data,
(e) biometric data is immediately analyzed by central processing unit for a match with wanted identity including and especially the wanted identity characteristics and/or biometric data of those in the missing child category,
(f) the biometric data may or may not be used in conjunction with the system in claim 1, but shall be used in conjunction with some universal database in order to be most effective.

15. The reverse identity profiling system of claim 14, whereby the devise is used with or built into any bank machine or credit processing devise.

16. The reverse identity profiling system of claim 14, whereby the devise is used with or built into any computer keyboard.

17. The reverse identity profiling system of claim 14, whereby the devise is used with or built into any help-phone or emergency phone on the street or highway, parking lot and/or other publicly accessible place.

18. The reverse identity profiling system of claim 14, whereby the devise is any devise containing a panic button of sorts and identity recognition devise which may be used conjunction with one another and may transmit location information and defining identity characteristics and/or biometric data to source(s) for emergency contact and/or evaluation.

19. The reverse identity profiling system of claim 14, whereby the devise is used in conjunction with, supplements and/or is built into any devise or alarm system with biometric identity capabilities whereby the system may be been manipulated to function bilaterally.

20. The reverse identity profiling system of claim 14, wherein the electronic defining identity characteristic and/or biometric data and related devise component is any one or combination of those listed in of claims 8, 9 and 10.

21. The reverse identity profiling system of claim 14, whereby the identity observation or verification devise component is any one or combination of devises noted in claims 11, 12, and 13.

22. The reverse identity profiling system of claim 14, whereby the system may be combined with any one or more of those of claim 1,2,3,4,5,6, and/or 7.

23. The reverse identity profiling system of claim 1,2,3,4,5,6, and/or 7, whereby the system aids in bringing identity related order to any group environment, specific or global, small or large and most specifically those groups of individuals displaced by disaster or nomadic type situations.
